(19) United States
(12) Patent Application Publication
(10) Pub. No.: US 2026/0132684 A1
(43) Pub. Date: May 14, 2026

(54) CONTINUOUS ROTATION COILED TUBING ORIENTING TOOL WITH SELF-REVERSING THREADS

(71) Applicant: Schlumberger Technology Corporation, Sugar Land, TX (US)

(72) Inventors: Ashley Bernard Johnson, Cambridge (GB); Jeremy Thomas Murphy, Sugar Land, TX (US)

(21) Appl. No.: 19/379,986

(22) Filed: Nov. 5, 2025

Related U.S. Application Data
(60) Provisional application No. 63/718,036, filed on Nov. 8, 2024.

(51) Int. Cl. E21B 7/06; E21B 17/20; E21B 44/00

(52) U.S. Cl. CPC E21B 7/062; E21B 17/20; E21B 44/00

(57) ABSTRACT

An orienting tool includes a first collar configured to rotate with respect to a second collar. A cylinder having self-reversing threads on an outer surface thereof is deployed in the first collar and rotationally coupled with the second collar. A piston assembly includes a threaded piston head configured to travel in first and second opposing axial directions along the self-reversing threads. Movement of the piston head along the cylinder rotates the cylinder and the rotationally coupled second collar in a single rotational direction. A hydraulic pump is deployed in the first collar and is configured to provide pressurized hydraulic fluid to the piston assembly to move the piston head along the cylinder.

### CROSS REFERENCE TO RELATED APPLICATIONS

This application claims the benefit of U.S. Provisional Application Ser. No. 63/718,036 entitled Continuous Rotation Orienting Tool for Coiled Tubing Drilling, filed Nov. 8, 2024, which is incorporated herein by reference in its entirety.

### BACKGROUND

Coiled tubing drilling operations are commonly utilized to drill high dogleg and horizontal wellbore sections. In such coiled tubing drilling operations, the drill bit and bottom hole assembly (BHA) are conveyed into the wellbore via a continuous length of jointless coiled metal tubing that is wound on a large diameter reel at the surface. The reel, pumps, and guides are mounted on a mobile surface unit, and an injector is used to drive the tubing into and out of the well. A mud motor or turbine is commonly employed to rotate the drill bit since the coiled tubing will not rotate in the wellbore.

A coiled tubing bottom hole assembly (BHA) commonly includes an orienting tool, one or more optional logging while drilling (LWD) tools, a measurement while drilling (MWD) tool, a motor or turbine, a bent sub, and a drill bit. When drilling a curved section, the orienting tool is turned to a desired toolface angle such that rotation of the drill bit drills the well along a curved path in the direction of the bent sub. When drilling straight ahead, the orienting tool may be rotated slowly back and forth between diametrically opposed toolface angles.

It will be appreciated that the above described approach for drilling straight ahead generally results in a wellbore having a tortuous profile. While such tortuosity may be reduced or eliminated by continuously rotating the orienting tool (e.g., as disclosed in U.S. Pat. No. 6,047,784), known implementations of electromechanically actuated orienting tools capable of continuous rotation have proven to be unreliable in commercial coiled tubing drilling operations. There is a need in the industry for a robust, continuous rotation orienting tool for coiled tubing drilling operations.

### SUMMARY

Coiled tubing orienting tools capable of continuous rotation are disclosed. In an example embodiment, the orienting tool includes a first collar configured to rotate with respect to a second collar. A cylinder having self-reversing threads on an outer surface thereof is deployed in the first collar and rotationally coupled with the second collar. A piston assembly is deployed in the first collar and includes a threaded piston head configured to travel in first and second opposing axial directions along self-reversing threads on the cylinder. The movement of the piston head along the cylinder rotates the cylinder and the rotationally coupled second collar in a single rotational direction. A hydraulic pump is deployed in the first collar and is configured to provide pressurized hydraulic fluid to the piston assembly to move the piston head along the cylinder (and thereby rotate the second collar).

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example coiled tubing drilling operation employing an orienting tool configured for continuous rotation.

FIGS. 2A and 2B (collectively FIG. 2) depict an example embodiment of an orienting tool capable of continuous rotation via active hydraulic control.

FIG. 3 depicts an example hydraulic circuit configured to provide active hydraulic control of the orienting tool shown on FIG. 2.

FIG. 4 depicts a flow chart of one example coiled tubing drilling method using the orienting tool disclosed in FIG. 2.

FIG. 5 depicts a flow chart of another example coiled tubing drilling method using the orienting tool disclosed in FIG. 2.

FIGS. 6A, 6B, and 6C (collectively FIG. 6) depict plots of wellbore azimuth, wellbore inclination, and dogleg severity on the vertical axes versus the measured depth of a straight wellbore section on the horizontal axis for simulated coiled tubing drilling operations.

FIGS. 7A and 7B (collectively FIG. 7) depict plots of wellbore diameter on the vertical axis versus the measured depth of a straight wellbore section on the horizontal axis for simulated coiled tubing drilling operations.

### DETAILED DESCRIPTION

Coiled tubing orienting tools capable of continuous rotation and coiled tubing drilling methods employing such orienting tools are disclosed. In one example embodiment, a disclosed orienting tool includes a cylinder having self-reversing threads on an outer surface thereof. The cylinder is deployed in a first collar and rotationally coupled with a second collar. A piston assembly is deployed in the first collar and includes a threaded piston head configured to travel in first and second opposing axial directions along self-reversing threads on the cylinder. The movement of the piston head along the cylinder rotates the cylinder and the rotationally coupled second collar in a single rotational direction with respect to the first collar (regardless of which direction the piston head travels). A hydraulic pump is deployed in the first collar and is configured to provide pressurized hydraulic fluid to the piston assembly to move the piston head along the cylinder (and thereby rotate the second collar).

Disclosed embodiments may advantageously provide an orienting tool capable of continuous rotation in a wellbore during a drilling operation. The disclosed orienting tool is hydraulically actuatable and may therefore provide improved reliability and service. Moreover, the disclosed embodiments may advantageously enable straight sections to be drilled with reduced tortuosity in coiled tubing drilling operations.

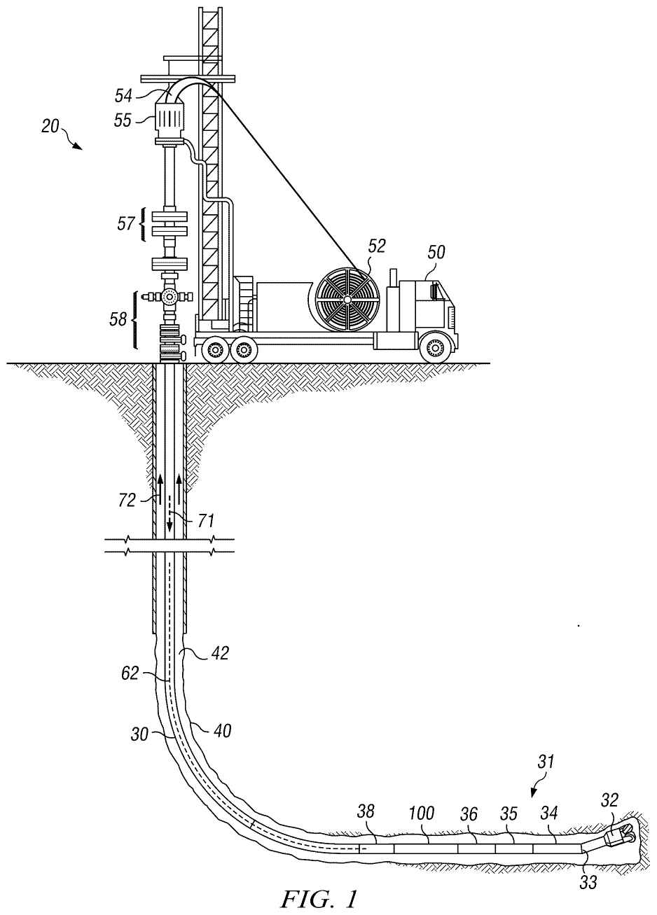

FIG. 1 depicts an example coiled tubing drilling operation 20 including a disclosed orienting tool 100 configured for continuous rotation. In the depicted example embodiment, coiled tubing 30 and other equipment may be delivered into a subterranean wellbore 40 in an oilfield by a truck 50 (or portable platform/rig). The truck 50 accommodates a coiled tubing reel 52 and equipment for threading the coiled tubing 30 through a gooseneck 54 and injector head 55 for advancement of the coiled tubing 30 into the wellbore 40. Other conventional equipment such as a blow-out preventor stack 57 and a master control valve 58 may be employed in directing the coiled tubing 30 into and out of the well 40 or preventing its uncontrollable release to the environment.

The orienting tool 100 may be deployed in a bottom hole assembly (BHA) 31 deployed on (connected to) the downhole end of the coiled tubing 30. The BHA 31 may include, for example, a drill bit 32, a bent housing 33, a mud motor or turbine 34 configured to rotate the drill bit, a measurement while drilling (MWD) tool 35, a logging while drilling (LWD) tool 36, the orienting tool 100, and a drilling head 38 including a disconnect (such as an electrical disconnect). It will be appreciated that the disclosed embodiments are, of course, not limited to any particular BHA configuration and may include other downhole tools than those depicted or fewer downhole tools than those depicted. For example, the use of an LWD tool may be purely optional.

The motor or turbine 34 may include a positive displacement motor or a turbine and may be configured to convert drilling fluid flow (hydraulic force) to rotary motion to rotate the drill bit 32 and drill the wellbore 40. The MWD tool 35 may be configured, for example, to measure wellbore attitude (inclination and azimuth), weight on bit (WOB), torque on bit (TOB), shock and vibration, BHA rotation rate, downhole pressure and temperature, and gamma ray counts, however, the disclosed embodiments are not limited to the use of an MWD tool including any particular sensor deployment.

Data generated by the MWD tool 35, the LWD tool 36, and/or other sensors in the BHA may be transmitted (communicated) uphole while drilling. For example, the data may be transmitted uphole in substantially real time via a wireline link 62. Moreover, control commands may be sent from the surface to the BHA via the wireline link 62. In some embodiments, electric power may also be provided to the BHA via the wireline link 62. For example, the orienting tool 100 may receive electrical power from the wireline link 62 and may communicate electrically via the link 62. As is known to those of ordinary skill in the art, the wireline link 62 may be routed along an interior of or within a wall of the coiled tubing 30.

As noted above, the coiled tubing 30 may be delivered downhole via an injector head 55. In certain embodiments, the injector head 55 may be controlled to slack off or pick up the coiled tubing 30 so as to control the amount of speed of tubing into the wellbore and, correspondingly, the WOB acting on the drill bit 32 or BHA 31. In this way, the rate of penetration (ROP) of the drilling operation may be controlled. Depending on the specifics of the coiled tubing operation, various types of data may be collected downhole, and transmitted to the surface. For example, the data may be used to fully or partially automate downhole operations, to optimize the downhole operations, and/or to provide more accurate predictions regarding components or aspects of the downhole operations as well as to integrate the control of the coiled tubing injection (and ROP), the BHA operation, and the managed pressure or underbalanced drilling.

During a coiled tubing drilling operation, drilling fluid is pumped downhole through the coiled tubing 30 (as depicted at 71) to the motor or turbine 34 to rotate the drill bit 32 and drill the well. As is known to those of ordinary skill in the art, the drilling fluid is also intended to carry cuttings and other debris, comingled or not with formation gases and fluids, to the surface in return flow 72 in the wellbore annulus 42. Coiled tubing drilling may be advantageous in certain drilling applications in that it will not require new stands of drill pipe to be added to a drill string and therefore enables continuous circulation of the drilling fluid and maintenance of smooth bottom hole pressure profiles. Coiled tubing drilling further readily enables underbalanced drilling that may deliver a wellbore having minimal (near zero) skin (or mudcake). Coiled tubing drilling is therefore commonly used to drill lateral or multilateral wellbore sections.

One disadvantage with the use of coiled tubing drilling is that it tends to have a limited lateral reach owing to the build-up of frictional force between the non-rotating coiled tubing and the wellbore wall. When frictional lockup occurs, the coiled tubing no longer advances in the well (such that drilling stops) regardless of the surface parameters (e.g., regardless of the WOB and drilling fluid flow rate). It will be appreciated that the frictional force between the coiled tubing and the wellbore tends to increase significantly with increasing wellbore tortuosity. Reducing wellbore tortuosity may therefore advantageously enable coiled tubing drilling to have increased lateral reach.

During a coiled tubing drilling operation, a curved section of wellbore may be drilled by rotating the orienting tool and bent sub to a predetermined or desired toolface. Continued pumping of the drilling fluid then causes drilling to proceed in a direction that turns towards the toolface of the bent sub. To drill straight ahead, for example, in a lateral, the orienting tool is commonly rotated back and forth between diametrically opposed toolface angles, which tends to cause a tortuous wellbore profile. While wellbore tortuosity may be reduced or substantially eliminated by continuously rotating the orienting tool, known implementations of electromechanically actuated orienting tools capable of continuous rotation have proven to be unreliable in commercial coiled tubing drilling operations. There is a need in the industry for a robust, continuous rotation (continuously rotating) orienting tool for coiled tubing drilling operations. The example embodiments described herein below make use of robust hydraulic actuation and/or hydraulic control and may therefore provide for a continuously rotatable orienting tool having improved reliability and may further advantageously enable laterals and other wellbore sections to be drilled with lower tortuosity.

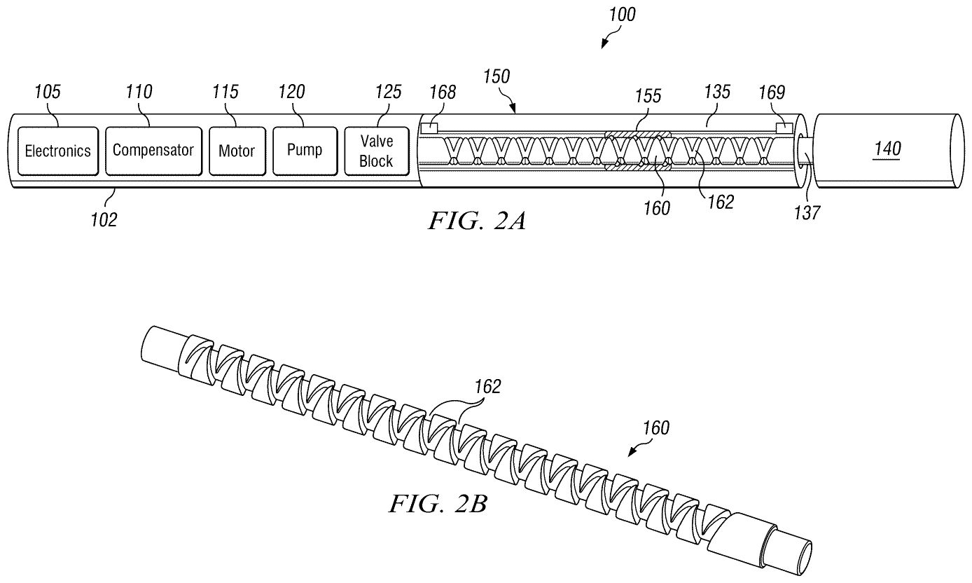

FIGS. 2A and 2B (collectively FIG. 2) depict an example embodiment of an orienting tool capable of continuous rotation via active hydraulic control. The orienting tool may include a first collar 102 configured to rotate with respect to a second collar 140. In example embodiments (such as depicted) the first collar 102 may be an upper collar and the second collar 140 may be a lower collar, however the disclosed embodiments are expressly not limited in this regard. Orienting tool 100 includes an electrical chassis 105, an oil compensator 110, an electrical motor 115, and a hydraulic pump 120 deployed in an first collar 102. A valve block 125 is in fluid communication with a piston assembly 150 that is configured to continuously rotate a second collar portion 140 of the orienting tool 100 (e.g., on demand).

The electrical chassis 105 may be connected with wireline 62 (FIG. 1) and may be configured to route electrical power to the electrical motor 115 (from the surface via the wireline 62). The electrical chassis further includes an electronic controller in electronic communication with the surface via wireline 62. In example embodiments, the controller may be configured to control smart solenoid valves (and therefore control orienting tool functionality) as described in more detail below.

The oil compensator 110 (or pressure compensator) may be configured to automatically modulate hydraulic fluid pressure within the orienting tool 100 (e.g., in the hydraulic pump assembly 120, the valve block 125, and the hydraulic motor). Substantially any suitable oil compensator may be utilized. In example embodiments the real compensator 110 may include an adjustable orifice to modulate fluid flow that is provided to the valve block and hydraulic motor. The disclosed embodiments are not limited to any particular oil compensator configuration.

In example embodiments, the hydraulic pump 120 may be powered by the electrical motor 115 (which in turn receives electrical power from the surface, for example, via power provided in wireline 62 through the electrical chassis 105 to the electrical motor 115). The hydraulic pump 120 may be configured to provide pressurized hydraulic fluid to the valve block 125 which is hydraulically coupled with a piston assembly 150 that is configured to continuously rotate the orienting tool as described in more detail below. The valve block may be configured to provide bidirectional flow from hydraulic pump 120 to piston assembly 150 such that threaded piston head 155 may be moved in either direction along the cylinder 160. By bidirectional flow it is meant that the pressurized hydraulic fluid may be selectively provided to either a first side or a second side piston assembly 150 such that it moves the threaded piston head in either first or second opposing directions along the cylinder 160.

It will be appreciated that the electrical chassis 105, the oil compensator 110, the electrical motor 115, the hydraulic pump 120, and the valve block 125 are not necessarily located in the relative positions shown in FIG. 2. For example, the oil compensator 110 is not necessarily located above the electrical motor 115. In alternative embodiments, the oil compensator may be located in proximity to the pump 120 or the valve block 125. Likewise, in alternative embodiments the electrical motor 115 may be deployed in proximity to the electronics chassis 105. The disclosed embodiments are not limited in these regards.

In the depicted example embodiment, the piston assembly 150 includes a threaded nut 155 (a piston head) that moves axially along and thereby rotates a cylinder 160 that has self-reversing (crisscross) threads 162 (FIG. 2B). The cylinder is rotationally coupled with shaft 137, which is in turn rotationally coupled with the second collar 140 such that rotation of the cylinder 160 via the traveling piston head 155 unidirectionally rotates the second collar 140. The crisscross thread pattern 162 on the cylinder 160 enables the piston head 155 to be hydraulically driven axially back and forth along the cylinder 160 without changing the cylinder's direction of rotation. It will be appreciated that the threaded nut 155 may include a follower blade that enables it to follow the crisscross threads 162.

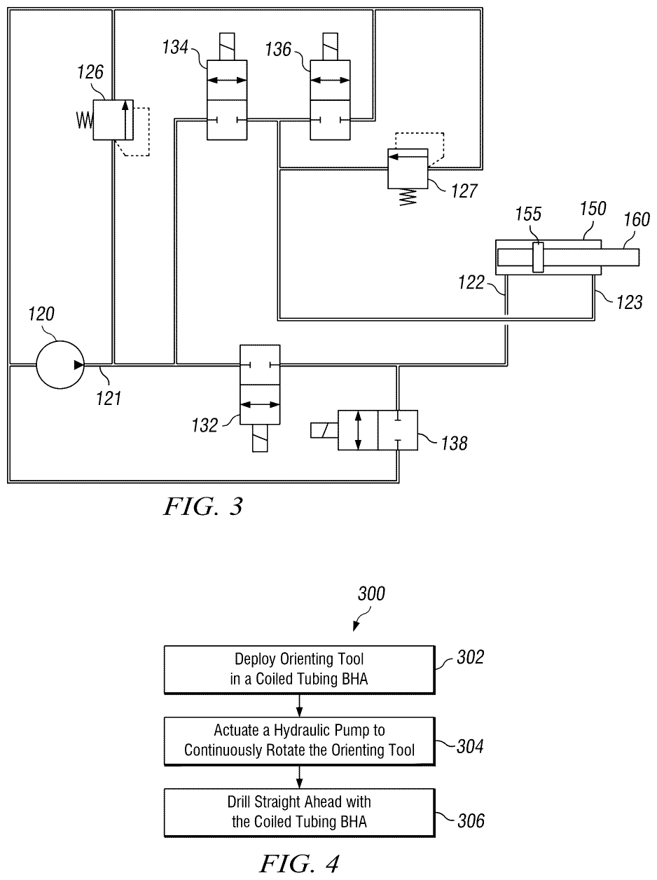

FIG. 3 depicts an example hydraulic circuit that is configured to provide active hydraulic control of the orienting tool 100 shown on FIG. 2. As depicted the hydraulic pump 120 provides pressurized drilling fluid to high pressure conduit 121. Fluid pressure in various lines may be limited via relief valves 126 and 127. A set of solenoid valves 132, 134, 136, 138 controls fluid flow to the piston assembly 150. Each of the solenoid valves 132, 134, 136, 138 is closed when the orienting tool 300 is at a fixed rotational orientation (toolface). Opening valves 132 and 136 (while valves 134 and 138 remain closed) provides high pressure fluid to conduit 122 which in turn moves the piston head (threaded nut 155) downwards (towards the second collar 140). Opening valves 134 and 138 (while valves 132 and 136 remain closed) provides high pressure fluid to conduit 123 which in turn moves the piston head (threaded nut 155) upwards (away from the second collar 140).

With continued reference to FIGS. 2 and 3, the solenoid valves 132, 134, 136, 138 may advantageously be smart (electronically controllable) solenoid valves in electronic communication with a controller (not shown), for example, located in the electrical chassis 105. As depicted in FIG. 2, the orienting tool 100 may further include first and second proximity sensors 168, 169 (such as Hall effect sensors) deployed at opposing axial ends of the threaded cylinder 160. The first and second proximity sensors 168, 169 may be configured to detect the piston head 155 when it is in proximity (e.g., as it approaches) corresponding first and second axial ends of the crisscross threads 162 on the cylinder 160.

In such embodiments, the controller may be configured to open and close valves in valve block 125 to auto reverse the flow of pressurized hydraulic fluid to the piston assembly when the threaded piston head 155 is detected to be in proximity to one of the first and second axial ends of the cylinder 160. For example, the controller may open and close selected ones of the smart solenoid valves 132, 134, 136, 138 to reverse the flow to piston assembly 150 when the piston head 155 approaches an axial end of the crisscross threads 162 (e.g., when the piston head 155 approaches one of the proximity sensors 168, 169). In this way the piston head 155 may travel axially back and forth along the length of the cylinder 160 causing the cylinder to rotate in one direction (unidirectionally) and thereby causing the second collar 140 to continuously rotate in the same direction.

With still further reference to FIG. 3, in example embodiments, the hydraulic pump 120 may advantageously include a variable speed pump that is controllable from the surface (e.g., via controlling a motor speed of the electrical motor 115). In such embodiments, increasing the pumping rate of the variable speed hydraulic pump increases a continuous rotation rate of the second collar with respect to the first collar and decreasing the pumping rate of the variable speed hydraulic pump decreases a continuous rotation rate of the second collar with respect to the first collar. In this way, the orienting tool 100 may be configured to have a variable (and controllable) continuous rotation rate. In example embodiments the rotation rate may be controlled over a range from about 0.1 rpm to about 20 rpm (e.g., from about 0.2 to about 10 rpm or from about 0.5 to about 5 rpm). The continuous rotation unidirectional and the hydraulic circuit may be configured such that the unidirectional rotation is in either the same direction or the opposite direction as the drill bit. The disclosed embodiments are not limited in this regard.

In example embodiments, the rotation rate may be controlled via closed loop control using toolface and/or rotation rate measurements made by the MWD tool 35 or by sensors in the orienting tool 100. For example, a tool controller (e.g., deployed in the electrical chassis 105) may receive such rotation rate measurements and use the received measurements in a feedback loop with the electrical motor 115 or hydraulic pump 120 such that the controller may decrease (e.g., incrementally decrease) the pump speed when the rotation rate measurements indicate that the rotation rate is greater than a desired rate or upper rate threshold and increase (e.g., incrementally increase) the pump speed when the rotation rate measurements indicate that the rotation rate is less than a desired rate or lower rate threshold.

With reference again to FIG. 2, while not depicted, it will be appreciated that the orienting tool 100 may further include a brake configured to secure or lock the orienting tool at a particular rotational orientation. For example, the brake may be engaged while steering and disengaged when drilling straight ahead continuously rotating the orienting tool. The brake may be deployed, for example, in the gearbox 135 or along shaft 137. In some embodiments, the brake may be hydraulically actuated. The brake may be released prior to actuating the hydraulic motor 120 to initiate the continuous rotation of the second collar 140.

FIG. 4 depicts a flow chart of one example coiled tubing drilling method 300 using the orienting tool disclosed in FIG. 2. A hydraulically actuated orienting tool (e.g., orienting tool 100) is deployed in a coiled tubing BHA which is in turn deployed in a wellbore at 302. A hydraulic pump in the orienting tool is actuated at 304 so as to pump hydraulic fluid and cause the orienting tool to continuously rotate in the wellbore. The coiled tubing BHA may then be used to drill straight ahead at 306 while the orienting tool continuously rotates in the wellbore. In example embodiments actuating the pump at 304 may further include releasing a brake to enable rotation of the orienting tool. Actuating the pump at 304 may still further include opening one or more valves (such as a smart solenoid valve) to deliver pressurized drilling fluid to a hydraulic motor which in turn continually rotates a lower sub of the orienting tool (e.g., second collar 140).

As described above the pump may be actuated at 304 by actuating an electrical motor to drive the pump. Moreover, the pumping rate may be incrementally increased or incrementally decreased (e.g., in response to rotation rate measurements of the second collar with respect to the first collar) by incrementally increasing or decreasing a motor speed of the electrical motor. The method may further include auto-reversing a travel direction of a threaded piston head when it is detected by one of the first and second proximity sensors (e.g., by opening and closing various valves as described above).

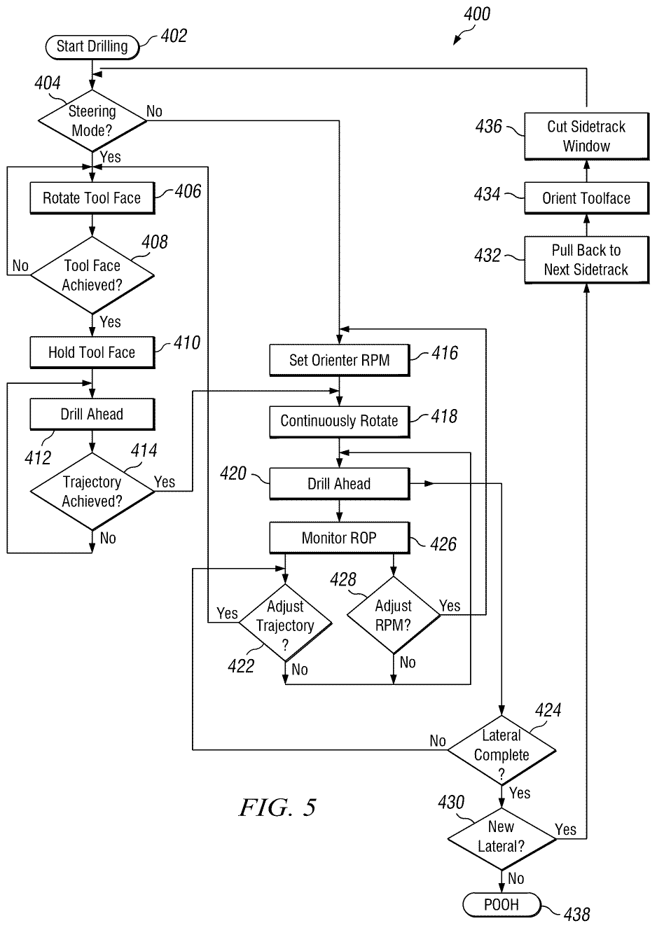

FIG. 5 depicts a flow chart of another example coiled tubing drilling method 400 using the orienting tool disclosed in FIG. 2. In the depicted example, drilling starts at 402 (e.g., after deployment of the coiled tubing string at the desired depth in the wellbore). When steering is employed at 404, the orienting tool may be rotated to point the bent sub to a predetermined toolface at 406. The toolface angle may be verified at 408, for example, using MWD measurements and secured or held at 410 using a brake or other suitable mechanism in the orienting tool. Drilling the curved section may then proceed at 412 until the desired trajectory has been achieved at 414.

When steering is not employed at 404 (such that the wellbore is intended to be drilled straight along the current trajectory), the orienting tool may be continuously rotated at a predetermined rotation rate at 416, 418 (e.g., by releasing the brake and actuating a hydraulic pump as described above). Drilling the straight section may then proceed at 420 until a trajectory adjustment is required at 422 or the lateral or straight wellbore section is completed at 424. The method may return to 406 when trajectory adjustment is required at 422. The rate of penetration may be optionally monitored at 426 and the continuous rotation rate of the orienting tool adjusted at 428 and 416, for example, to provide an optimum ROP/RPM ratio and to minimize wellbore tortuosity.

In example embodiments in which the coiled tubing drilling operation 400 is used to drill laterals, the method may pull back to the next side track depth at 432 when the drilling plan includes an additional lateral at 430. Upon arriving at the side track depth, the orienting tool may be rotated to a predetermined side track toolface at 434 and the sidetrack window may be cut at 436 before returning to 402 to initiate lateral drilling. In the event that no additional lateral sections are required, the coiled tubing string may be pulled out of the hole at 438.

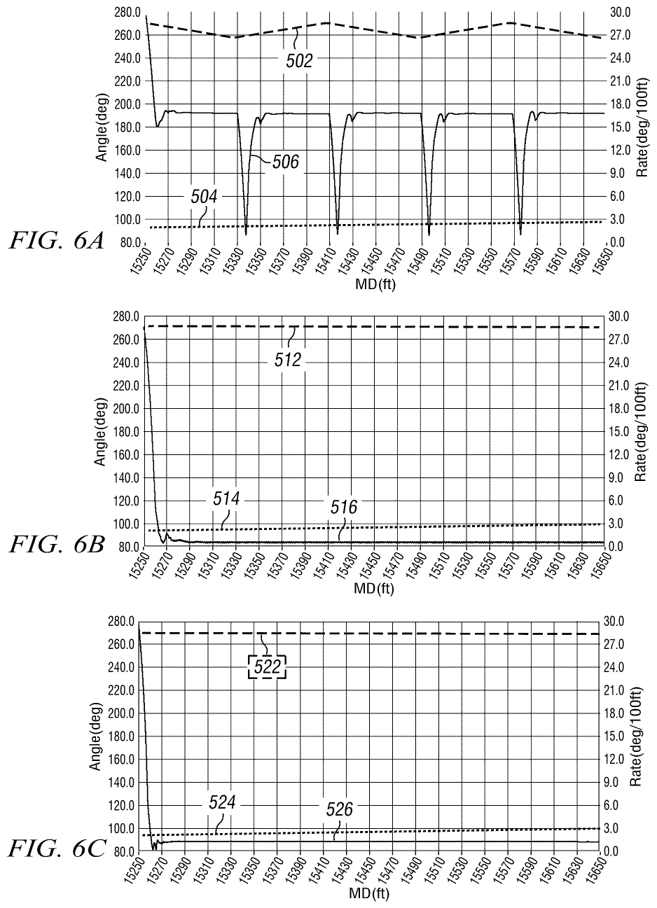

FIGS. 6A, 6B, and 6C (collectively FIG. 6) depict plots of wellbore azimuth 502, 512, 522 wellbore inclination 504, 514, 524, and dogleg severity 506, 516, 526 on the vertical axes versus measured depth of a straight wellbore section on the horizontal axis for a simulated coiled tubing drilling operation. In the simulation shown on FIG. 6A, the orienting tool was rotated back and forth between diametrically opposed toolface angles at a measured depth interval of about 80 ft (about 25 m). Note that the wellbore azimuth 502 oscillated back and forth between about 258 degrees and 272 degrees and that the dogleg severity was about 17 degrees per 100 ft (except when the orienting tool was rotated). In the simulation shown on FIG. 6B, the orienting tool was rotated continuously at a rotation rate of 0.5 rpm. Note that the azimuth remained steady at about 272 degrees and the dogleg severity was about 1 degree per 100 ft. In the simulation shown on FIG. 6C, drilling was simulated with a straight BHA (no bent sub). Note that the azimuth remained steady at about 272 degrees and the dogleg severity was about 1 degree per 100 ft. Note also that the continuous rotation of the orienting tool at a rotation rate of 0.5 rpm advantageously produced an essentially identical wellbore to drilling with a straight BHA.

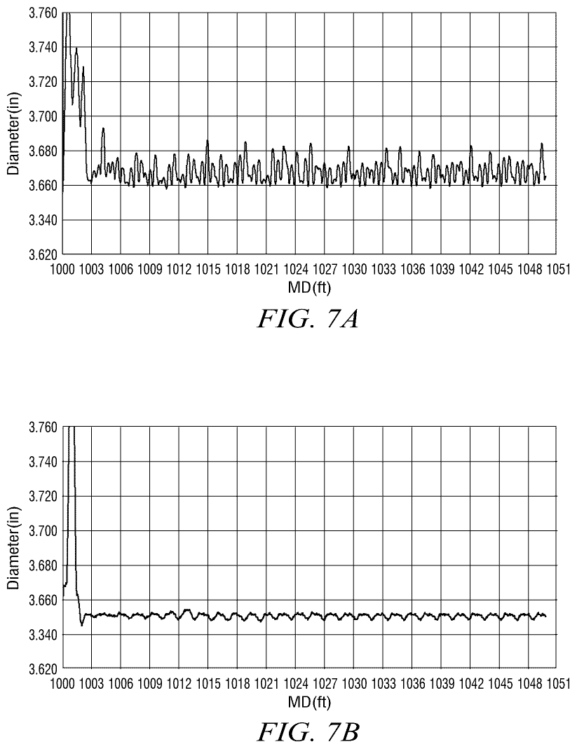

FIGS. 7A and 7B depict plots of wellbore diameter on the vertical axis versus measured depth of a straight wellbore section on the horizontal axis for simulated coiled tubing drilling operations. In FIG. 7A the orienting tool rotated continuously at 0.5 rpm and the ROP was 20 ft/hr. In FIG. 7B the orienting tool rotated continuously at 0.5 rpm and the ROP was 50 ft/hr. Note that the wellbore diameter was greater at the lower rate of penetration (7A) indicating a lower wellbore tortuosity. These simulations indicate that the wellbore tortuosity may depend on the rotation rate of the orienting tool and the rate of penetration of drilling and that it may be advantageous to make use of higher orienting tool rotation rates when the rate of penetration is higher. As indicated above in FIG. 5, the rotation rate of the orienting tool may be adjusted at 428 in response to the measured rate of penetration at 426.

While not disclosed in FIG. 2, it will be appreciated that the disclosed orienting tool embodiments may further include one or more electronic controllers configured, for example, to execute closed loop control of the rotation rate as well as to control smart (controllable) components in the orienting tool. A suitable controller may include, for example, a programmable processor, such as a digital signal processor or other microprocessor or microcontroller and processor-readable or computer-readable program code embodying logic. A suitable controller may also optionally include other controllable components, such as other sensors, data storage devices, power supplies, timers, and the like. A suitable controller may also optionally communicate with the surface as well as other instruments in the BHA, such as, for example, the MWD tool. A suitable controller may further optionally include volatile or non-volatile memory or a data storage device.

Although a continuous rotation coiled tubing orienting tool with self-reversing threads has been described in detail, it should be understood that various changes, substitutions and alternations can be made herein without departing from the spirit and scope of the disclosure as defined by the appended claims.

We claim:

1. An orienting tool for using in a coiled tubing bottom hole assembly, the orienting tool comprising:
a first collar configured to rotate with respect to a second collar;
a cylinder having self-reversing threads on an outer surface thereof, the cylinder deployed in the first collar and rotationally coupled with the second collar;
a piston assembly deployed in the first collar and including a threaded piston head configured to travel in first and second opposing axial directions along self-reversing threads on the cylinder and thereby rotate the cylinder and the rotationally coupled second collar in a single rotational direction; and
a hydraulic pump deployed in the first collar and configured to provide pressurized hydraulic fluid to the piston assembly to move the piston head along the cylinder.

2. The orienting tool of claim 1, further comprising an electrical motor deployed in the first collar and configured to power the hydraulic pump.

3. The orienting tool of claim 1, wherein the hydraulic pump is a variable speed hydraulic pump, wherein increasing a pumping rate increases a continuous rotation rate of the second collar.

4. The orienting tool of claim 3, further comprising an electronic controller configured to:
receive a rotation rate measurement of the second collar;
incrementally decrease a pump speed of the variable speed hydraulic pump when the rotation rate measurement exceeds a first upper threshold; and
incrementally increase a pump speed of the variable speed hydraulic pump when the rotation rate measurement is less than a second lower threshold.

5. The orienting tool of claim 1, further comprising:
first and second proximity sensors deployed at opposing axial ends of the threaded cylinder, the first proximity sensor configured to detect the threaded piston head when it is in proximity to a first axial end of the cylinder, the second proximity sensor configured to detect the threaded piston head when it is in proximity to a second axial end of the cylinder; and
a valve block configured to auto reverse the flow of pressurized hydraulic fluid to the piston assembly when the threaded piston head is in proximity to one of the first and second axial ends of the cylinder.

6. The orienting tool of claim 5, wherein the first and second proximity sensors comprise Hall effect sensors.

7. The orienting tool of claim 1, further comprising a valve block in fluid communication with the hydraulic motor, the valve block configured to provide bidirectional fluid flow to the piston assembly to selectively urge the threaded piston head to travel in the first axial direction or the second axial direction along the cylinder.

8. The orienting tool of claim 7, wherein the valve block comprises first, second, third, and fourth electronically actuatable solenoid valves, the first and second electronically actuatable solenoid valves in fluid communication with the pressurized hydraulic fluid provided by the hydraulic pump and the third and fourth electronically actuatable solenoid valves in fluid communication with a return flow line, wherein opening the first and third electronically actuatable solenoid valves while closing the second and fourth electronically actuatable solenoid valves urges the threaded piston in the first direction and opening the second and fourth electronically actuatable solenoid valves while closing the first and third electronically actuatable solenoid valves urges the threaded piston in the second direction.

9. The orienting tool of claim 8, further comprising:
first and second proximity sensors deployed at opposing axial ends of the threaded cylinder, the first proximity sensor configured to detect the threaded piston head when it is in proximity to a first axial end of the cylinder, the second proximity sensor configured to detect the threaded piston head when it is in proximity to a second axial end of the cylinder; and
a controller configured to open and close selected ones of the first, second, third, and fourth electronically actuatable solenoid valves to reverse fluid flow to the piston assembly and thereby reverse a travel direction of the threaded piston head when it is detected by one of the first and second proximity sensors.

10. The orienting tool of claim 1, further comprising a brake configured to prevent rotation of the second collar with respect to the first collar.

11. A method for coiled tubing drilling comprising:
deploying a coiled tubing bottom hole assembly in a wellbore, the bottom hole assembly including an orienting tool comprising a first collar configured to rotate with respect to a second collar, a cylinder having self-reversing threads on an outer surface thereof, the cylinder deployed in the first collar and rotationally coupled with the second collar, a piston assembly deployed in the first collar and including a threaded piston head configured to travel in first and second opposing axial directions along self-reversing threads on the cylinder and thereby rotate the cylinder and the rotationally coupled second collar in a single rotational direction, and a hydraulic pump deployed in the first collar and configured to provide pressurized hydraulic fluid to the piston assembly to move the piston head along the cylinder;
actuating the hydraulic pump to continuously rotate the second collar with respect to the first collar; and
using the coiled tubing bottom hole assembly to drill the wellbore while the second collar rotates with respect to the first collar.

12. The method of claim 11, further comprising:
receive a rotation rate measurement of the second collar;
incrementally decreasing a pump speed of the hydraulic pump to decrease a rotation rate of the second collar with respect to the first collar when the rotation rate measurement exceeds a first upper threshold; and
incrementally increasing a pump speed of the hydraulic pump increase a rotation rate of the second collar with respect to the first collar when the rotation rate measurement is less than a second lower threshold.

13. The method of claim 12, wherein the orienting tool further comprises an electrical motor configured to power the hydraulic pump, wherein the incrementally decreasing the pump speed comprises incrementally decreasing a motor speed of the electric motor, and wherein the incrementally increasing the pump speed comprises incrementally increasing the motor speed of the electric motor.

14. The method of claim 11, wherein:
the orienting tool further comprises first and second proximity sensors deployed at opposing axial ends of the threaded cylinder, the first proximity sensor configured to detect the threaded piston head when it is in proximity to a first axial end of the cylinder, the second proximity sensor configured to detect the threaded piston head when it is in proximity to a second axial end of the cylinder; and
the method further comprises auto-reversing a travel direction of the threaded piston head when it is detected by one of the first and second proximity sensors.

15. The method of claim 11, wherein:
the orienting tool further comprises a brake configured to prevent rotation of the second collar with respect to the first collar, and
the method further comprises releasing the break prior to actuating the hydraulic pump.

16. An orienting tool configured for use in a coiled tubing bottom hole assembly, the orienting tool comprising:
a first collar configured to rotate with respect to a second collar;
a cylinder having self-reversing threads on an outer surface thereof, the cylinder deployed in the first collar and rotationally coupled with the second collar;
a piston assembly deployed in the first collar and including a threaded piston head configured to travel in first and second opposing axial directions along self-reversing threads on the cylinder and thereby rotate the cylinder and the rotationally coupled second collar in a single rotational direction;
a hydraulic pump deployed in the first collar and configured to provide pressurized hydraulic fluid to the piston assembly to move the piston head along the cylinder;
first and second proximity sensors deployed at opposing axial ends of the threaded cylinder, the first proximity sensor configured to detect the threaded piston head when it is in proximity to a first axial end of the cylinder, the second proximity sensor configured to detect the threaded piston head when it is in proximity to a second axial end of the cylinder; and
a controller configured to selectively open and close a plurality of valves to reverse the flow of pressurized hydraulic fluid to the piston assembly when the threaded piston head is in proximity to one of the first and second axial ends of the cylinder and thereby reverse a travel direction of the threaded piston head along the cylinder.

17. The orienting tool of claim 16, wherein the first and second proximity sensors comprise Hall effect sensors.

18. The orienting tool of claim 16, further comprising a valve block including first, second, third, and fourth electronically actuatable solenoid valves, the first and second electronically actuatable solenoid valves in fluid communication with the pressurized hydraulic fluid provided by the hydraulic pump and the third and fourth electronically actuatable solenoid valves in fluid communication with a return flow line, wherein opening the first and third electronically actuatable solenoid valves while closing the second and fourth electronically actuatable solenoid valves urges the threaded piston in the first direction and opening the second and fourth electronically actuatable solenoid valves while closing the first and third electronically actuatable solenoid valves urges the threaded piston in the second direction, wherein the controller is configured to open and close selected ones of the first, second, third, and fourth electronically actuatable solenoid valves to reverse the flow of the pressurized hydraulic fluid.

19. The orienting tool of claim 16, wherein:
the hydraulic pump is a variable speed hydraulic pump, wherein increasing a pumping rate increases a continuous rotation rate of the second collar; and
the controller is further configured to:
receive a rotation rate measurement of the second collar;
incrementally decrease a pump speed of the variable speed hydraulic pump when the rotation rate measurement exceeds a first upper threshold; and
incrementally increase a pump speed of the variable speed hydraulic pump when the rotation rate measurement is less than a second lower threshold.

20. The orienting tool of claim 19, further comprising:
an electrical motor deployed in the first collar and configured to power the variable speed hydraulic pump; and
wherein the controller is configured to incrementally decrease a motor speed of the electric motor to decrease the pump speed and incrementally increase the motor speed of the electric motor to increase the pump speed.
